(19) United States
(12) Patent Application Publication
(10) Pub. No.: US 2005/0165502 A1
(43) Pub. Date: Jul. 28, 2005

(54) Method, system and computer-readable medium for generating a multi-channel audio signal from a monophonic audio signal

(76) Inventor: David H. Hanes, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/765,805

(22) Filed: Jan. 27, 2004

(51) Int. Cl. G06F 17/00

(52) U.S. Cl. 700/94

(57) ABSTRACT

A method of processing an audio stream comprises receiving a digital audio stream and automatically determining the received digital audio stream comprises a single channel of audio data and automatically generating a multi-channel audio stream having at least two audio channels each comprising the single channel of audio data.

### TECHNICAL FIELD

This invention relates to multimedia technologies and, more particularly, to a method, system, and computer-readable medium for generating a multi-channel audio signal from a monophonic audio signal.

### BACKGROUND

Many video camcorder users desire to convert their recorded home movies or other video and audio onto a more permanent storage medium. An optical storage device, e.g., a digital versatile disc (DVD), is a desirable storage medium due to the permanence of the optic disc. Additionally, DVDs offer a better viewing experience than analog playback devices. For example, video and audio stored on a DVD is randomly accessible and has attractive search options not available on various analog and digital tape formats used by most camcorders and video cassette recorders (VCRs). Additionally, storage of video and audio on a digital storage device provides exact reproduction from copy to copy.

The majority of home movies recorded by camcorders are stored on various analog storage media, e.g., video tapes such as VHS, 8 mm, hi-8, VHS-C, and the like. When transferring analog video and audio to a digital medium such as an optic storage disc, the analog source is first converted to a digital signal. Specialized hardware often referred to as a capture or compression card is used for the analog-to-digital conversion. The digital signal output by the capture card is supplied to mastering software that is used to write the digitized video and audio to the digital medium.

Many older video cassette recorders and analog camcorders have a single channel audio-out port. When such a device is interconnected with a capture or compression card for converting the analog video and audio signals into a digital format, a single channel of audio signals is recorded to the optic medium. Often, the user is not aware that such a problem exists until playback of the optic disc results in a single channel of monophonic audio emitted from a single speaker channel of the playback audio system. To avoid a single channel monophonic playback, the user must use a splitter cable to duplicate the single channel audio and supply the split audio signals into a respective right and left channel of the capture card.

### SUMMARY OF THE INVENTION

A method of processing an audio stream comprises receiving a digital audio stream and automatically determining the received digital audio stream comprises a single channel of audio data and automatically generating a multi-channel audio stream having at least two audio channels each comprising the single channel of audio data.

A system, comprising an analog-to-digital conversion device adapted to receive an analog signal and convert the analog signal into a digital signal, and an analysis application adapted to automatically determine the digital signal comprises a monophonic audio signal and generate a multi-channel signal having at least two audio channels each comprising the monophonic audio signal.

In accordance with yet another embodiment of the present invention, a computer-readable medium is provided having stored thereon an instruction set to be executed, the instruction set, when executed by a processor, causes the processor to receive a digital signal comprising monophonic audio data. The processor generates an audio signal having at least two audio channels each comprising the monophonic audio data.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of a system for processing an analog video/audio signal according to embodiments of the invention;

FIGS. 2A and 2B are, respectively, a diagrammatic illustration of a digitized audio stream supplied to an analysis application by an analog-to-digital conversion device, and a multi-channel audio stream generated by the analysis application in accordance with embodiments of the invention;

FIGS. 2C and 2D are, respectively, a diagrammatic illustration of a digitized audio stream supplied to an analysis application, and a multi-channel audio stream generated by the analysis application in accordance with embodiments of the invention; and

FIG. 3 is a simplified block diagram of a computer system operable to execute an analysis application for generating a multi-channel audio stream from an analog, monophonic audio signal in accordance with embodiments of the invention.

### DETAILED DESCRIPTION OF THE DRAWINGS

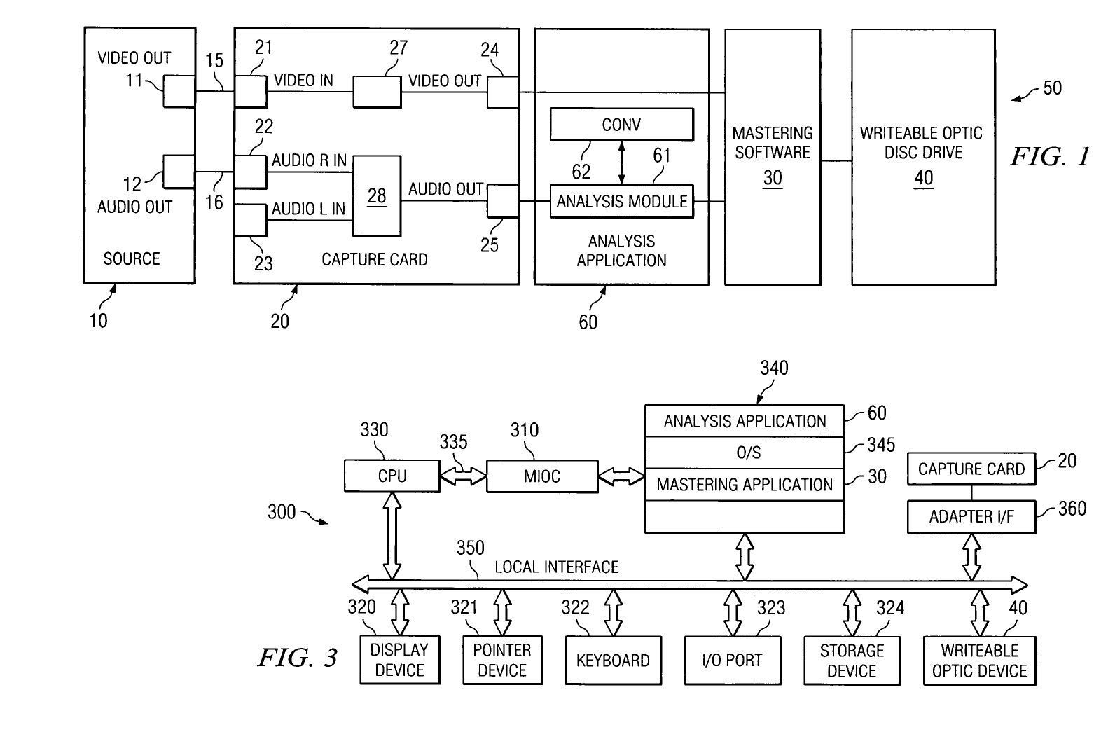

The preferred embodiment of the present invention and its advantages are best understood by referring to FIGS. 1 through 3 of the drawings, like numerals being used for like and corresponding parts of the various drawings.

FIG. 1 is a simplified block diagram of a system 50 for processing an analog video and audio (V/A) signal in accordance with embodiments of the invention. An analog device 10, e.g., a video cassette recorder, an analog camcorder, or another device, is interconnected with a capture card 20. Capture card 20 comprises a video-in port 21 and right (R) and left (L) audio-in ports 22 and 23. In the illustrative example, a video-out port 11 of analog device 10 is interconnected with video-in port 21 of capture card 20 by a cable 15, e.g., a coaxial cable. An audio-out port 12 of analog device 10 is interconnected with one of audio-in ports 22 and 23 of capture card 20 by a cable 16, e.g., a coaxial cable, a 3.5 mm audio cable, or another suitable transmission medium.

Capture card 20 is typically implemented as a daughter card that interfaces with an expansion slot, e.g., a peripheral component interconnect (PCI) interface, of a personal computer backplane, e.g., a motherboard. In general, capture card 20 comprises a graphics chipset 27 for converting an analog video signal, e.g., a video signal formatted according to the national television standards committee (NTSC) format, the phase alternating line (PAL) format, or another suitable format, supplied at port 21 and outputting a corresponding digital video signal over a video-out interface 24. Video-out interface 24 may comprise one or more pins interfacing with an expansion slot of a host computer. Video and audio-out interfaces 24 and 25 may be implemented as a single V/A-out interface, e.g., one or more pins, and the digitized video and audio signals may be interleaved and output over the single V/A-out interface. Similarly, capture card 20 comprises an audio chipset 28 for converting analog audio received at ports 22 and/or 23 and outputting a corresponding digital audio signal over an audio-out interface 25. In general, audio chipset 28 comprises encoding logic adapted to receive an analog right channel audio signal and an analog left channel audio signal over right and left audio-in ports 22 and 23, respectively, and encode the received audio signals into a digital audio signal such as a moving pictures experts group (MPEG) audio stream. Graphics chipset 27 functionality and audio chipset 28 functionality may, alternatively, be integrated into a single chipset.

In the illustrative example, capture card 20 is adapted to convey digital video and audio signals from respective chipsets 27 and 28 to an analysis application 60 for further processing and formatting into a format suitable for storage on a digital medium such as a DVD in accordance with embodiments of the invention. In the illustrative example, application 60 comprises an audio analysis module 61 and a stream conversion module 62. Analysis application 60 is preferably implemented as a computer-readable instruction set comprising logic for analyzing a digital audio stream and evaluating whether monophonic audio data is present in the audio stream. In the event that monophonic audio data is present in the audio stream, analysis application 60 generates a multi-channel audio stream by duplicating the audio data and inserting the original audio data first into a first audio channel and a copy of the audio data into a second audio channel of the generated audio stream.

In the illustrative example, analog device 10 comprises a single audio-out port 12 interconnected with right channel audio-in port 22. No audio signal is supplied to left channel audio-in port 23. Accordingly, audio chipset 28 produces a monophonic audio stream and conveys the stream to analysis application 60. In general, a monophonic audio stream supplied to analysis application 60 comprises a digital audio stream having a single channel of audio data. The monophonic audio stream may have additional audio channels with no audio content present. In the absence of an audio signal supplied to an audio-in port, e.g., left audio-in port 23, corresponding left channel data of the digitized audio signal output from capture card 20 is nulled or absent. Analysis application 60 generates a multi-channel audio stream with duplicated audio signals for at least two audio channels and supplies the generated stream to a mastering software 30 application. In general, mastering software 30 application comprises a computer-readable instruction set comprising logic for formatting the received digital video and audio signals into a format suitable for storage on an optic disc, and for playback from an optic storage player device. For example, mastering software 30 may format the received video and audio streams into a video object comprising video and audio suitable for storage on a DVD on a writeable optic disc drive 40 and for playback on a DVD player.

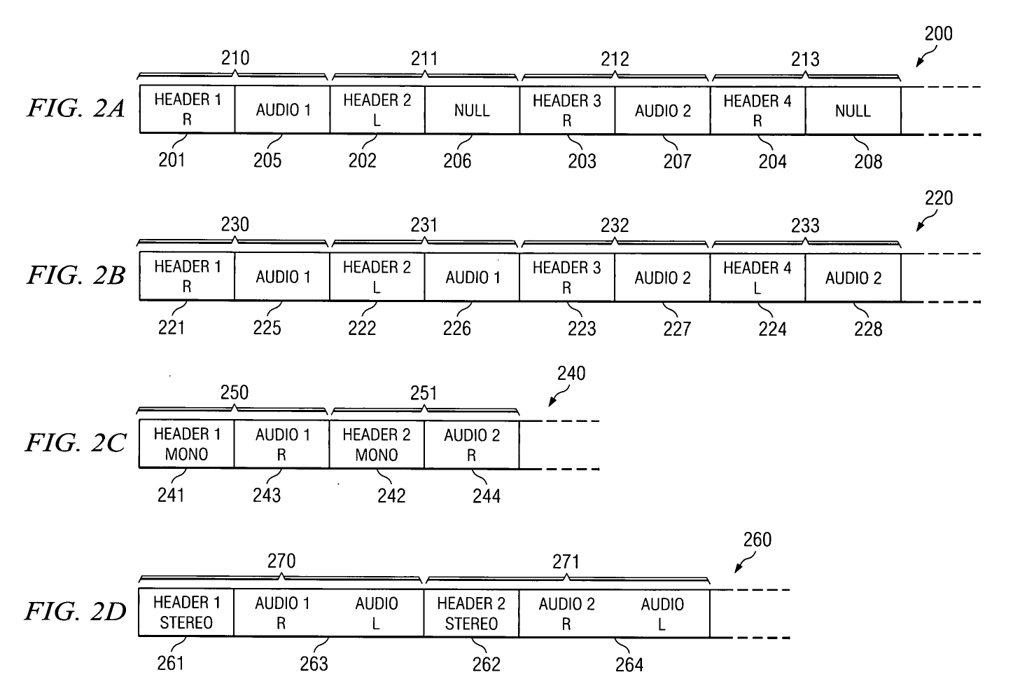

Capture card 20 may compress the digital video and audio signals prior to conveying the video and audio to mastering software 30. Preferably, audio chipset 28 encodes the audio signal in, for example, an MPEG audio layer such as MPEG 1, MPEG 2, or MPEG 2.5, or another compressed format. In general, the digital audio signal output by capture card 20 comprises a digitally-encoded audio stream having a sequence of frames. In FIG. 2A, there is an exemplary diagrammatic illustration of a digital audio stream 200 supplied to analysis application 60 by capture card 20 in accordance with the configuration of system 50 shown in FIG. 1. Audio stream 200 comprises a series of right (R) and left (L) channel audio frames 210-213. Each frame 210-213 comprises a respective header 201-204 and information field 205-208. In the illustrative example, right and left channel audio frames are interleaved in audio stream 200. Particularly, frames 210 and 212 are designated as right (R) channel frames and frames 211 and 213 are designated as left (L) channel frames. Designation of frames 210-213 as a right or left channel frame is made, for example, by a respective bit sequence included in header 201-204. In the illustrative example, right channel frames 210 and 212 comprise respective audio data (audio1 and audio2) in information fields 205 and 207, and left channel frames 211 and 213 do not have any audio data. That is, information fields 206 and 208 are nulled by, for example, a bit sequence indicating the absence of audio content. Alternatively, left channel frames 211 and 213 may comprise only headers 202 and 204.

In accordance with embodiments of the invention, analysis module 61 comprises logic for analyzing audio stream 200 and determining that monophonic audio content is present. In the illustrative example, analysis module 61 comprises logic for determining the absence of audio content within one or more of frames 210-213. For example, analysis module 61 may read the contents of information fields 205-208, or a portion thereof, and determine the presence of a null bit sequence within fields 206 and 208. Additionally, analysis module 61 may evaluate headers 202 and 204 to determine that nulled information fields 206 and 208 comprise left channel information fields.

Upon determining that left channel audio is absent from audio stream 200, conversion module 62 generates a multi-channel audio stream 220 comprising right channel frames 230 and 232 and left channel frames 231 and 233 as shown by the diagrammatic illustration of multi-channel audio stream 220 in FIG. 2B. Audio stream 220 is generated by reading the audio data (audio1) of information field 205 and writing the audio data to fields 225 and 226 of generated audio stream 220. Frame 230 is designated as a right channel audio frame, e.g., by writing a bit sequence or other indicator into a header 221 of frame 230, and frame 231 is designated as a left channel audio frame in a similar manner. Likewise, the audio data (audio2) read from field 207 is written to fields 227 and 228 of stream 220 of respective frames 232 and 233. Frames 232 and 233 are designated as right and left channel frames by writing an appropriate bit sequence in respective headers 223 and 224. It should be apparent that audio stream 220 may be generated by modification of audio stream 200. For example, audio stream 200 may be converted to a multi-channel audio stream by inserting a frame adjacent to each frame determined to comprise monophonic audio data and copying the monophonic audio data into the inserted frame. Other techniques may be implemented for generation of multi-channel audio stream 220 as will be recognized by those skilled in the art. Stream 220 is then passed to mastering software 30 for preparation of writing to a digital storage medium.

While the exemplary embodiment described with reference to FIGS. 2A and 2B describes audio stream 200 formatted for interleaving left and right channel frames with the audio stream, analysis module 61 may be adapted to analyze any stream format now known or later developed for monophonic audio content. For example, capture card 20 may output a digital audio stream 240 in which single frames carry one or more channel data as shown in the diagrammatic illustration of FIG. 2C. Audio stream 240 is generally formatted according to the well-known MPEG audio compression format. Particularly, audio stream 240 comprises a series of audio frames 250-251 respectively comprising a header 241 and 242 and information field 243 and 244. Headers 241 and 242 provide an indication, e.g., a bit sequence, that indicates the audio-type of content in a subsequent information field 243 and 244, respectively. For example, an MPEG-formatted audio stream comprises a 2-bit filed within headers 241 and 242 that indicates a channel mode. TABLE A summarizes channel mode bit patters within an MPEG-formatted audio stream.

TABLE A

| Bit-pattern | Channel Mode |
|---|---|
| 00 | Stereo |
| 01 | Joint Stereo (Stereo) |
| 10 | Dual Channel (Stereo) |
| 11 | Single Channel (Mono) |

The illustrative audio stream 240 in FIG. 2C comprises a series of frames 250 and 251 each having a respective information field 243 and 244 having right channel audio data (audio1 (R) and audio2(R)). Headers 241 and 242 include a bit pattern, e.g., a bit pattern of “11”, that indicates the audio content within the frame is monophonic. That is, the audio data of frames 250 and 251 comprises single channel audio data. Analysis module 61 is adapted to evaluate audio stream 240 and determine that single channel audio is included therein. For example, analysis module 61 reads headers 241 and 242 and evaluates the channel mode bit sequence for an indication of monophonic audio content. In the illustrative example, the audio content (audio1(R) and audio2(R)) of each information field 243 and 244 is copied by conversion module 62 in accordance with embodiments of the invention. The copied data is interleaved as left channel audio data with the original right channel audio data of information fields 63 and 264 of a generated multi-channel audio stream 260 as shown by the diagrammatic illustration of FIG. 2D. The original audio data (audio1(R) and audio2(R)) constitutes right channel audio data of stream 260 and the copied audio data (audio1(L) and audio2(L)) constitutes left channel audio data of stream 260. Preferably, conversion module 62 writes a bit sequence within headers 261 and 262 that indicates audio stream 260 comprises multi-channel audio content. In the illustrative example, conversion module 62 writes a bit pattern of “00” in headers 261 and 262 thus indicating respective frames 270 and 271 comprise stereo content. Accordingly, a decoder, e.g., a DVD player having a decoder adapted to playback stream 260 (or a derivation thereof), identifies audio steam 260 as comprising multi-channel audio content and playback results in audible output from multiple channels from a multi-channel stereo system.

FIG. 3 is a simplified block diagram of a computer system 300 operable to execute analysis application 60 in accordance with embodiments of the invention. System 300 comprises one or more conventional processing elements 330 such as a central processing unit (CPU) connected to a memory and input/output controller (MIOC) 310 via a system bus 335. Processing element 330 communicates with and drives the other elements within system 300 via a local interface 350, which may comprise one or more busses. MIOC 310 receives access requests over system bus 335 and addresses a memory device 340 and/or other input/output (I/O) devices communicatively coupled with local interface 350. For example, a display device 320, a pointer device (such as a mouse 321), a keyboard 322, an I/O port 323, and a storage device 324 are communicatively coupled with MIOC 310 via local interface 350. Memory device 340 may be implemented as a non-volatile storage, such as a read only memory (ROM), a volatile storage, such as a random-access memory (RAM), a dynamic random-access memory, a flash electrically-erasable programmable read only memory, or another storage device. System 300 stores application 60 in storage device 324. A writeable optic disc drive 40, e.g., a writeable compact disc drive or a writeable digital versatile disc drive, is communicatively coupled with processing element 330.

Through conventional techniques, analysis application 60 and/or mastering software 30 application are fetched from storage device 324, loaded in memory device 340, and executed by an operating system (O/S) 345 and processing element 330. Operating system 345 controls the resources of system 300 through conventional techniques and interfaces the instructions of application 60 with processing element 330 as necessary to enable application 60 to properly run. However, it should be noted that analysis application 60 and mastering software 30 may be located remotely from one another and may reside on different computing platforms.

An adapter interface 360, for example a peripheral component interconnect, an integrated drive electronics (IDE) interface, a Small Computer System Interface (SCSI), or another peripheral interface, is interconnected with local interface 350 and provides a communication coupling between capture card 20 and processing element 330. Adapter interface 360 is implemented as a socket, or expansion slot, and associated circuitry disposed on a backplane, e.g., a motherboard, of system 300. Capture card 20, e.g., a daughter card, is coupled with adapter interface 360 and, in turn, may be coupled with a multimedia source, e.g., analog device 10.

Embodiments of the present invention provides that analog video and audio signals supplied to capture card 20 are converted to corresponding digital video and audio signals. The digital video and audio signals are conveyed to processing element 330 and processed according to the instruction set of analysis application 60. Multi-channel audio is generated from a single channel monophonic audio signal. The multi-channel audio signal is passed to mastering software 30 application for writing to an optic disc by writeable optic disc device 40.

Analysis application 60 is preferably implemented as an instruction set(s), or program, of computer-readable logic. The instruction set is preferably maintained on any one of various conventional computer-readable mediums. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium now known or later developed.

1. A method of processing an audio stream, comprising:
receiving a digital audio stream;
automatically determining the received digital audio stream comprises a single channel of audio data; and
automatically generating a multi-channel audio stream having at least two audio channels each comprising the single channel of audio data.

2. The method according to claim 1, wherein receiving a digital audio stream further comprises receiving a sequence of audio frames.

3. The method according to claim 1, further comprising copying the single channel audio data from a first frame in the digital audio stream.

4. The method according to claim 3, further comprising inserting a second frame after the first frame, the inserted frame comprising the copied audio data.

5. The method according to claim 4, wherein inserting the copied single channel of audio data further comprises interleaving the copied audio data with the audio data of the first frame.

6. The method according to claim 1, wherein automatically generating a multi-channel audio stream further comprises duplicating the audio data within a frame of a sequence of frames in the received digital audio stream.

7. The method according to claim 6, wherein duplicating the audio data further comprises duplicating the audio data within each frame of the sequence of frames determined to comprise audio data.

8. The method according to claim 1, wherein automatically determining further comprises determining a plurality of frames of the audio stream comprise monophonic audio data.

9. The method according to claim 1, further comprising:
transmitting an analog monophonic audio signal to an analog-to-digital conversion device; and
converting the analog monophonic audio signal to the digital audio stream.

10. The method according to claim 9, wherein transmitting an analog monophonic audio signal comprises transmitting analog video and audio content to the analog-to-digital conversion device.

11. The method according to claim 1, wherein automatically determining further comprises evaluating a bit sequence of the received digital audio stream.

12. The method according to claim 11, wherein generating a multi-channel audio stream further comprises writing a channel mode bit sequence into a frame header of the generated multi-channel audio stream, the bit sequence indicating multi-channel audio data is contained in the multi-channel audio stream.

13. The method according to claim 12, wherein writing a channel mode bit sequence into the header further comprises writing a stereo channel mode bit sequence.

14. A system, comprising:
an analog-to-digital conversion device adapted to receive an analog signal and convert the analog signal into a digital signal; and
an analysis application adapted to automatically determine the digital signal comprises a monophonic audio signal and generate a multi-channel signal having at least two audio channels each comprising the monophonic audio signal.

15. The system according to claim 14, wherein the analog-to-digital conversion device comprises a video capture card.

16. The system according to claim 14, wherein the analog-to-digital conversion device comprises an interface for receiving the analog signal from an analog source device.

17. The system according to claim 14, further comprising a mastering software application adapted to receive the generated signal and process the generated signal for writing to a storage medium.

18. The system according to claim 17, wherein the storage medium comprises an optic disc.

19. A computer-readable medium having stored thereon an instruction set operable to cause the processor to:
receive a digital signal comprising monophonic audio data;
generate an audio signal having at least two audio channels each comprising the monophonic audio data.

20. The computer-readable medium according to claim 19, wherein the processor is operable to generate a sequence of frames each having an associated header, and writing a bit sequence in each header indicating the associated frame comprises multi-channel audio content.

21. The computer-readable medium according to claim 19, wherein the processor is operable to duplicate audio data of each frame.

22. The computer-readable medium according to claim 21, wherein the processor is operable to interleave the duplicated audio data within an information field of the respective frame.

23. The computer-readable medium according to claim 19, wherein receiving a digital audio signal further comprises receiving an audio signal comprising a sequence of frames each having respective monophonic audio data, and generating an audio signal further comprises copying the respective monophonic audio data of each frame of the sequence, wherein the instruction set, when executed by the processor, further causes the processor to:
insert a respective frame for each of the frames of the sequence; and
write the respective copied audio data into one of the inserted frames.

24. The computer-readable medium according to claim 19, wherein the processor is operable to receive video data and monophonic audio data.
